(19) United States
(12) Patent Application Publication
(10) Pub. No.: US 2026/0277878 A1
(43) Pub. Date: Sep. 17, 2026

(54) ELECTRONIC DEVICE AND METHOD FOR MANAGING DATABASE USING HIGH-SPEED STORAGE

(71) Applicant: Samsung Electronics Co., Ltd., Suwon-si (KR)

(72) Inventors: Hyeeun JUN, Suwon-si (KR); Hobin WOO, Suwon-si (KR); Kisung LEE, Suwon-si (KR); Yoonho SHIN, Suwon-si (KR)

(21) Appl. No.: 19/676,134

(22) Filed: May 13, 2026

Related U.S. Application Data
(63) Continuation of application No. PCT/KR2024/019358, filed on Nov. 29, 2024.

(30) Foreign Application Priority Data
Dec. 20, 2023 (KR) 10-2023-0187780
Feb. 6, 2024 (KR) 10-2024-0018496

(51) Int. Cl. G06F 16/23; G06F 21/62

(52) U.S. Cl. CPC G06F 16/2379; G06F 21/6218

(57) ABSTRACT

An electronic device is provided. The electronic device includes memory including a first storage and a second storage with faster access speed than the first storage storing instructions, and at least one processor comprising processing circuitry, wherein the instructions, when executed by the at least one processor individually or collectively cause the electronic device to verify, using information related to a database stored in the memory, whether authority to perform read and write operations on the database using the second storage from among the first storage and the second storage is granted, based on verifying that the authority has been granted, execute a function of generating, in the second storage, journal information related to a database stored in the first storage, based on the execution of the function, update, based on the journal information stored in the second storage, the journal information stored in the second storage according to a transaction related to the database, and based on the execution of the function, generate journal information in the first storage based on identifying that the journal information is not generated in the second storage by the execution of the function, generate the journal information in the first storage.

### CROSS-REFERENCE TO RELATED APPLICATION(S)

This application is a continuation application, claiming priority under 35 U.S.C. § 365(c), of an International application No. PCT/KR2024/019358, filed on Nov. 29, 2024, which is based on and claims the benefit of a Korean patent application number 10-2023-0187780, filed on Dec. 20, 2023, in the Ministry of Intellectual Property (MOIP), and of a Korean patent application number 10-2024-0018496, filed on Feb. 6, 2024, in the Ministry of Intellectual Property (MOIP), the disclosure of each of which is incorporated by reference herein in its entirety.

### BACKGROUND

### 1. Field

The disclosure relates to an electronic device and a method for managing a database using a high-speed storage.

### 2. Description of Related Art

An electronic device may include a storage device. In the storage device, a database, which is a collection of data, may be stored. The electronic device may configure a system for managing the database.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for managing a database using a high-speed storage.

Additional aspects will be set forth in part in the description which follows and, in part, will be apparent from the description, or may be learned by practice of the presented embodiments.

In accordance with an aspect of the disclosure, an electronic device is provided. The electronic device includes memory including a first storage and a second storage having a faster access speed than the first storage storing instructions, and at least one processor, including processing circuitry, wherein the instructions, when executed by the at least one processor individually or collectively, cause the electronic device to verify, using information related to a database stored in the memory, whether authority to perform read and write operations on the database using the second storage from among the first storage or the second storage is granted, based on verifying that the authority is granted, execute a function of generating, in the second storage, journal information related to the database stored in the first storage, and based on the execution of the function, based on the journal information stored in the second storage, update the journal information stored in the second storage according to a transaction related to the database, based on identifying that the journal information is not generated in the second storage by the execution of the function, generate the journal information in the first storage.

In accordance with another aspect of the disclosure, an electronic device is provided. The electronic device includes memory including a first storage area and a second storage area having a faster access speed than the first storage area storing instructions, and at least one processor, including processing circuitry, wherein the instructions, when executed by the at least one processor individually or collectively, cause the electronic device to confirm, using information related to a database stored in the memory, whether managing a database using the second storage area from among the first storage area or the second storage area is permitted, based on confirming that managing the database using the second storage area is permitted, execute a function of generating, in the second storage area, journal information related to the database stored in the first storage area, based on the execution of the function, based on the journal information stored in the second storage area, update the journal information stored in the second storage area according to a transaction related to the database, and based on identifying that the journal information is not generated in the second storage area by the execution of the function, generated the journal information in the first storage area.

In accordance with another aspect of the disclosure, a method performed by an electronic device including memory including a first storage and a second storage having a faster access speed than the first storage is provided. The method includes confirming, using information related to a database stored in the memory, whether managing the database using the second storage from among the first storage or the second storage is permitted, based on confirming that managing the database using the second storage is permitted, executing a function of generating, in the second storage, journal information related to the database stored in the first storage, based on the execution of the function, based on the journal information stored in the second storage, updating the journal information stored in the second storage according to a transaction related to the database, and based on identifying that the journal information is not generated in the second storage by the execution of the function, generating the journal information in the first storage.

In accordance with another aspect of the disclosure, one or more non-transitory computer-readable storage media storing one or more computer programs including computer-executable instructions that, when executed by one or more processor of an electronic device including memory including a first storage and a second storage having a faster access speed than the first storage individually or collectively, cause the electronic device to perform operations are provided. The operations include confirming, using information related to a database stored in the memory, whether managing the database using the second storage from among the first storage or the second storage is permitted, based on confirming that managing the database using the second storage is permitted, executing a function of generating, in the second storage, journal information related to the database stored in the first storage, and based on the execution of the function, based on the journal information stored in the second storage, updating the journal information stored in the second storage according to a transaction related to the database, and based on identifying that the journal information is not generated in the second storage by the execution of the function, generate the journal information in the first storage.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a program according to an embodiment of the disclosure;

FIG. 3 is a block diagram of an electronic device according to an embodiment of the disclosure;

FIG. 4 is a block diagram of an electronic device according to an embodiment of the disclosure;

FIG. 5 is a flowchart illustrating a method for configuring high-speed storage journaling according to an embodiment of the disclosure;

FIG. 6 is a flowchart illustrating a method for determining whether use of a high-speed storage is permitted according to an embodiment of the disclosure;

FIG. 7 is a flowchart illustrating a method for generating a journal directory of a high-speed storage according to an embodiment of the disclosure;

FIG. 8 is a flowchart illustrating a method for identifying journal file path information according to an embodiment of the disclosure;

FIG. 9 is a flowchart illustrating a method for processing a transaction using a high-speed storage in a rollback journal mode according to an embodiment of the disclosure;

FIG. 10 is a flowchart illustrating a method for generating a journal file in a write ahead logging (WAL) mode according to an embodiment of the disclosure;

FIG. 11 is a flowchart illustrating a method for processing a transaction using a high-speed storage in a WAL mode according to an embodiment of the disclosure;

FIG. 12 is a flowchart illustrating a method for determining whether a path change of a journal file is required by preliminarily evaluating a capacity of a high-speed storage according to an embodiment of the disclosure;

FIG. 13 is a flowchart illustrating a method for changing a journal file path in a WAL mode according to an embodiment of the disclosure; and

FIG. 14 is a flowchart illustrating a method for updating journal information in a WAL mode according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

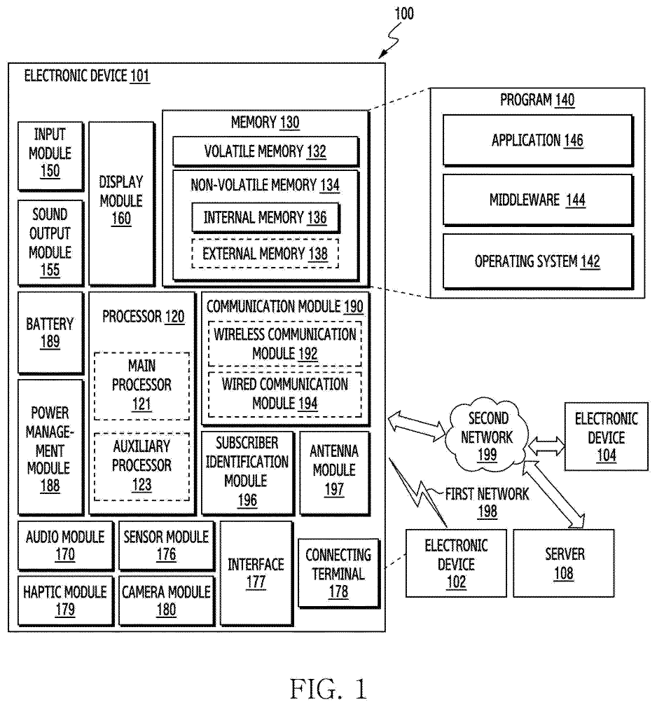

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

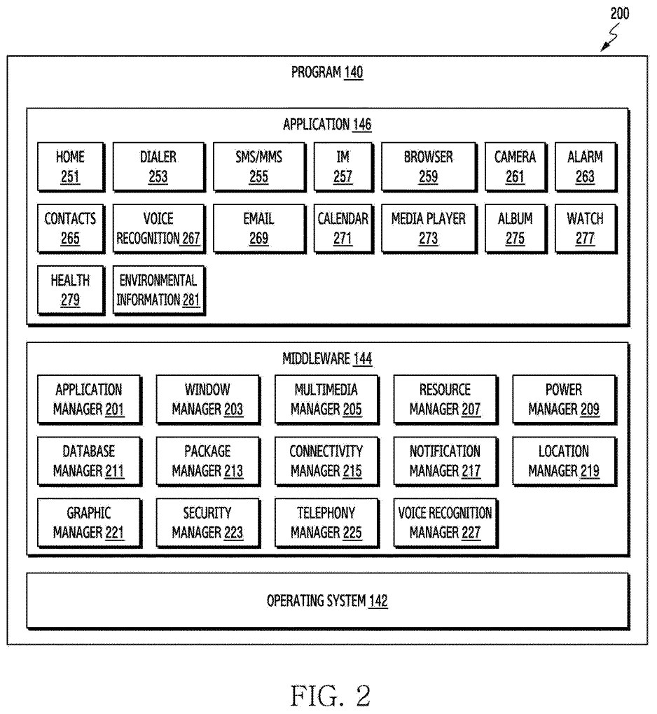

FIG. 2 is a block diagram 200 illustrating a program according to an embodiment of the disclosure.

Referring to FIG. 2, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the external electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input module 150, the sound output module 155, the display module 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment of the disclosure, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment of the disclosure, the middleware 244 may dynamically delete some existing components or add new components. According to an embodiment of the disclosure, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment of the disclosure, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display module or a camera module of the external electronic device). The device management application, additionally or alternatively, may support installation, delete, or update of an application running on the external electronic device.

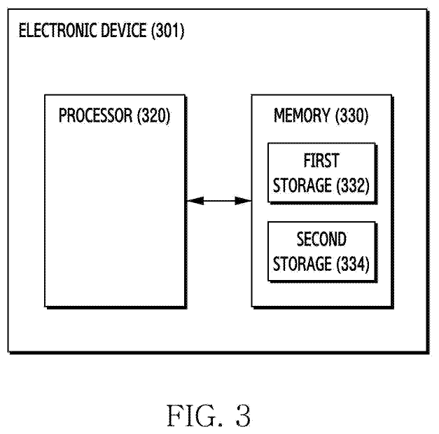

FIG. 3 is a block diagram of an electronic device according to an embodiment of the disclosure.

Referring to FIG. 3, an electronic device 301 according to an embodiment may be an example of the electronic device 101 of FIG. 1. For example, the electronic device 301 may include at least one of the components of the electronic device 101 of FIG. 1. For example, the electronic device 301 may include a processor 320 (e.g., the processor 120 of FIG. 1) and memory 330 (e.g., the memory 130 of FIG. 1).

In an embodiment of the disclosure, the memory 330 may include volatile memory (e.g., the volatile memory 132 of FIG. 1) and non-volatile memory (e.g., the non-volatile memory 134 of FIG. 1). In an embodiment of the disclosure, the memory 330 (or the non-volatile memory) may include a first storage 332 and a second storage 334. In an embodiment of the disclosure, the first storage 332 and the second storage 334 may each be formed in separate physically distinguished memories, or may be formed as logically distinguished in one memory 330, or may be formed as physically distinguished in one memory 330. In an embodiment of the disclosure, at least one of the first storage 332 or the second storage 334 may be formed in a structure electrically connected to memory (not illustrated) external to the electronic device 301. In an embodiment of the disclosure, the electronic device 301 may further include one or more storages in addition to the first storage 332 and the second storage 334.

In an embodiment of the disclosure, the second storage 334 may have higher performance than the first storage 332. For example, the second storage 334 may have a faster access speed (e.g., input/output speed) than the first storage 332. In an embodiment of the disclosure, the second storage 334 having a faster access speed than the first storage 332 may be referred to as high-speed storage, and the first storage 332 may be referred to as low-speed storage or legacy storage. In an embodiment of the disclosure, the second storage 334 may have a smaller capacity than the first storage 332, but it is not limited thereto.

In an embodiment of the disclosure, the first storage 332 and the second storage 334 may include storage devices of the same type or different types from each other. For example, the first storage 332 and/or the second storage 334 may include at least one of persistent memory (PMEM), erasable programmable read-only memory (EPROM), electrically erasable PROM (EEPROM), mask read-only memory (ROM), flash ROM, flash memory, a hard drive, or a solid state drive (SSD).

In an embodiment of the disclosure, the first storage 332 and/or the second storage 334 may have a form of internal memory included in the electronic device 301 or a form of external memory detachable from the electronic device 301.

Although the first storage 332 and the second storage 334 have been described as storage devices independent of each other or physically separated, it is not limited thereto. For example, the first storage 332 and/or the second storage 334 may include a storage area configured by one or more storage devices. For example, the first storage 332 and/or the second storage 334 may include a logical unit (LU) of flash memory compliant with a universal flash storage (UFS) standard (e.g., UFS 4.0) published by a joint electron device engineering council (JEDEC). For example, the first storage 332 may include an LU of UFS operating in a multi-level cell (MLC) mode or a triple level cell (TLC) mode, and the second storage 334 having a faster access speed than the first storage 332 may include an LU operating in a single level cell (SLC) mode or an MLC mode. In this regard, the first storage 332 and/or the second storage 334 may be referred to as a storage device or a storage area.

In an embodiment of the disclosure, the processor 320 may be operatively and/or electrically connected to the memory 330. The processor 320 may perform operations and/or data processing related to control and/or communication of various components of the electronic device 301 by executing instructions stored in the memory 330.

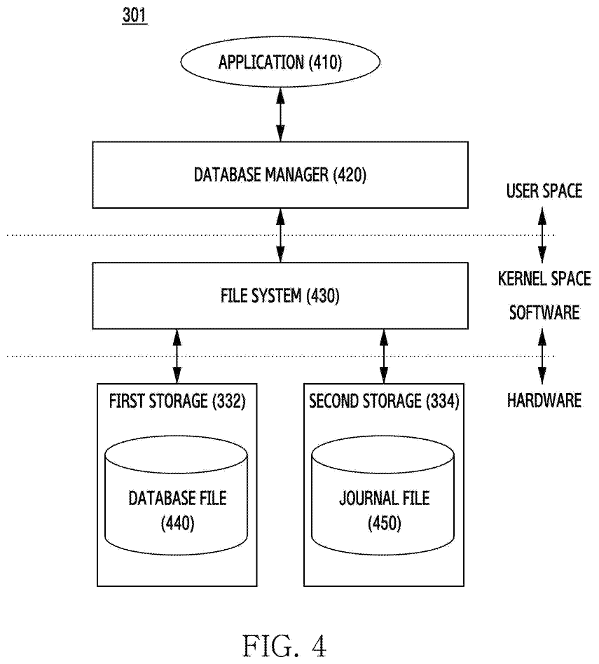

FIG. 4 is a block diagram of an electronic device according to an embodiment of the disclosure.

Referring to FIG. 4 together with FIG. 3, an electronic device 301 according to an embodiment may include an application 410 (e.g., the application 146 of FIG. 2), a database manager 420 (e.g., the database manager 211 of FIG. 2), and a file system 430, which are implemented on an operating system (e.g., the operating system 142 of FIG. 2) of the electronic device 301. For example, the application 410 and the database manager 420 may be executed on a user space, and the file system 430 may be executed on a kernel space. The user space may correspond to an area formed in volatile memory (e.g., the volatile memory 132 of FIG. 1) of the electronic device 301 for execution of an application program (e.g., the application 410). The kernel space may correspond to an area formed in the volatile memory of the electronic device 301 for execution of another program (e.g., system software included in the operating system 142) different from the application program.

In an embodiment of the disclosure, the application 410, the database manager 420, and the file system 430 may be executed by a processor 320 of the electronic device 301 or on the processor 320. For example, the application 410, the database manager 420, and the file system 430 may be stored in memory (e.g., the memory 330 of FIG. 3) of the electronic device 301 in a form executable by the processor 320. In an embodiment of the disclosure, the application 410, the database manager 420, and the file system 430 may be classified as software, and a first storage 332 and a second storage 334 may be classified as hardware.

In an embodiment of the disclosure, the file system 430 may mean a rule for storing information in the memory (e.g., the non-volatile memory) of the electronic device 301, one or more programs configured to store, retrieve, and/or delete information in the memory according to the rule, or any combination thereof.

In an embodiment of the disclosure, the database manager 420, a database file 440, and the application 410 may configure a database or a database system of the electronic device 301.

In an embodiment of the disclosure, the processor (e.g., the processor 320 of FIG. 3) of the electronic device 301 executing the database manager 420 may manage the database file 440. As a non-limiting example, the processor of the electronic device 301 may perform operations of reading (e.g., retrieving) and updating data included in the database file 440, and adding data to the database file 440 by using the database manager 420. For example, the database manager 420 may perform an operation for modifying data of the database file 440 according to various journal modes to be described later. The database manager 420 may, for example, perform the above-described operation based on a command received from the application 410 through an application programming interface (API). In an embodiment of the disclosure, the database manager 420 may include various database management systems. As a non-limiting example, the database manager 420 may include SQLite, H2, HSQL, Apache Derby, and/or Firebird Embedded Server.

In an embodiment of the disclosure, the first storage 332 may store the database file 440. Data related to the application 410 may be stored in the database file 440. For example, the application 410 may invoke (or call) an API provided by the database manager 420 in order to access the database file 440, store data in the database file 440, or at least partially update the database file 440. As a non-limiting example, the database file 440 may include a database file based on SQLite. The number of database files 440 stored in the first storage 332 is not limited by the example illustrated in FIG. 4. For example, unlike the illustration, there may be a plurality of database files 440.

In an embodiment of the disclosure, the database file 440 may include a plurality of pages. Each page may have a fixed size. As a non-limiting example, a size of each of the pages may be 4 KB. A first page among the plurality of pages may be configured with a database header and a schema, and remaining pages may be configured with content of the database file 440 and a data structure for improving a search speed of the database file 440. The header of the database file 440 is for identifying a type and integrity of a file, and may have a fixed size. For example, in a case of SQLite, the header may have a size of 100 bytes, but is not limited thereto and may vary according to a type of the database. The header may include a magic string, a page size, a journal mode, a total database size, and a schema cookie of the database file 440. When the database file 440 is a relational database, the schema may be located in one or more pages of the database file. In an embodiment of the disclosure, each of the plurality of pages of the database file 440 may correspond to each of nodes of data of a table stored in a form of a B-tree. A leaf page of a B-tree may include actual data. A page header including a type of a page and the number of data may be included at a beginning portion of the page. Following the page header, cell pointers corresponding to the number of records may be included. The cell pointers may indicate a location of record data in the page.

In an embodiment of the disclosure, a journaling method for guaranteeing atomicity of a transaction related to the database file 440 may be applied. The transaction may mean a unit of operation performed to change a state of the database file 440. For example, the transaction may be a logical unit of work (LUW) of operations related to data of the database file 440 and may be a unit of interaction between the application 410 and the database file 440. An operation related to data of the database file 440 may mean an operation of accessing the database file 440 based on a structured query language (SQL), which is text starting with an operand (or query), such as, for example, OPEN, SELECT, INSERT, DELETE, UPDATE, or CLOSE. One transaction may mean a set of one or more operations and/or queries related to data of the database file 440. In an embodiment of the disclosure, operations included in the transaction and related to data of the database file 440 may include a data read operation, a data addition operation, a data deletion operation, and a data modification operation. A commit of the transaction may mean that all operations related to data included in the transaction are successfully performed. The atomicity may mean that a result of processing data of the database file 440 based on all operations included in one transaction is either fully reflected in the database file 440 or not reflected at all.

In an embodiment of the disclosure, the journaling method of the database file 440 may include, for example, a rollback journal mode and a write ahead logging (WAL) mode. In an embodiment of the disclosure, a journal file 450 may be used for the rollback journal mode or the WAL mode. The journal file 450 may store journal information according to a transaction of the rollback journal mode or the WAL mode.

The rollback journal mode may store original data of the database file 440 before being modified by a transaction in the journal file 450, and data of the database file 440 may be modified (e.g., added, updated, or deleted) according to the transaction in a state in which the original data of the database file 440 is stored. Even when a problem occurs during modification of the database file 440, recovery may be performed using the original data of the database file 440 stored in the journal file 450. The journal file 450 in which the original data of the database file 440 is stored may be referred to as a rollback journal file. According to an embodiment of the disclosure, the database manager 420 may support various rollback methods, such as Persist, Truncate, and Delete according to an invalidation method for the journal file.

The WAL mode may create or generate the journal file 450 (e.g., a WAL file) before storing data in the database or performing operations of adding, modifying, or deleting data previously stored in the database, according to a type of transaction. According to an embodiment of the disclosure, a result of processing an operation related to the transaction may be stored in the WAL file. In an embodiment of the disclosure, before modifying the database file 440 according to the transaction, results of processing operations (e.g., a modification log of the database file 440) according to the transaction may be stored in the journal file 450. Thereafter, by reflecting the results of processing operations stored in the journal file 450 in the database file 440, data of the database file 440 may be modified (e.g., addition, update, or deletion of data) according to the transaction. Accordingly, even when an error occurs while the results of processing operations of the transaction are being stored in the journal file 450, data integrity may be secured because the database file 440 is maintained in an original state. The journal file 450 in which the results of processing operations according to the transaction are recorded in the WAL mode may be referred to as a WAL file. In an embodiment of the disclosure, a checkpoint may be performed to transfer data written to the WAL file to the database file 440. Due to multiple write transactions, a plurality of pages reflecting changes may be appended to the WAL file. Accordingly, a size of the WAL file may increase and read performance may be degraded. For example, as the size of the WAL file increases, a capacity occupied by the WAL file in storage increases, and storage may be used inefficiently. The checkpoint may be performed to prevent such a problem. Since threads executing the checkpoint operate synchronously, another operation may not be performed until the checkpoint is completed. For example, while the checkpoint is in progress, other read and write transactions may not be permitted. By using a unit of work referred to as the threads (or instances and/or processes), the processor of the electronic device 301 may execute instructions of different software applications substantially simultaneously. When operations (e.g., checkpoints) related to the database file 440 are performed substantially simultaneously using each of a plurality of threads, atomicity of the database file 440 may not be guaranteed, so the processor may synchronously perform operations of the plurality of threads related to the database file 440.

In an embodiment of the disclosure, the journal file 450 may be stored in the second storage 334. When a write transaction is completed in the rollback journal mode, the journal file 450 may be deleted or a size of the journal file 450 may be reduced to approximately 0 (e.g., truncate). After the checkpoint in the WAL mode, the journal file 450 may be deleted or the size of the journal file 450 may be reduced to approximately 0.

In an embodiment of the disclosure, since the journal file 450 is temporarily stored to guarantee atomicity in a write transaction of the database file 440, creation and deletion of the journal file 450 may be repeated. When the journal file 450 is stored in the first storage 332 in which the database file 440 is stored, fragmentation and degradation of performance of the first storage 332 may occur due to the repeated creation and deletion of the journal file 450. To prevent this, the database file 440 may be directly stored in the second storage 334 having higher performance than the first storage 332. However, such a method may be impossible because, in general, a size of the database file 440 tends to increase and a capacity of the second storage 334 is also limited. In addition, when the journal file 450 is fixedly used in the second storage 334, execution of a transaction may fail due to a lack of available capacity of the second storage 334.

The electronic device 301 according to an embodiment of the disclosure may store the journal file 450 in the first storage 332 or the second storage 334 according to various conditions in order to reduce fragmentation of the first storage 332 and efficiently use the second storage 334, which is a high-speed storage. For example, the electronic device 301 according to an embodiment may confirm, using setting information related to the database stored in the memory, whether managing the database using the second storage 334 from among the first storage 332 or the second storage 334 is permitted. After confirming that managing the database using the second storage 334 is permitted, the electronic device 301 may create the journal file 450 related to the database file 440 (or the database) stored in the first storage 332, in the second storage 334. The electronic device 301 may, based on failure to create the journal file 450 in the second storage 334, create the journal file 450 in the first storage 332. According to an embodiment of the disclosure, in the electronic device 301 using two types of storages, a journal file path management scheme utilizing xattr may be used to store a rollback journal file and a WAL journal file in a path of the second storage 334 which is a high-speed storage, instead of a database path of the first storage 332 which is a legacy storage.

Hereinafter, operations of the electronic device 301 will be described with reference to FIGS. 3 and 4 together. The operations described below may be performed by at least one component of the electronic device 301. For example, the operations described below may be performed by the processor 320 of the electronic device 301. For example, instructions stored in the memory 130, when executed by the processor 320, may cause the electronic device 301 to perform the operations described below.

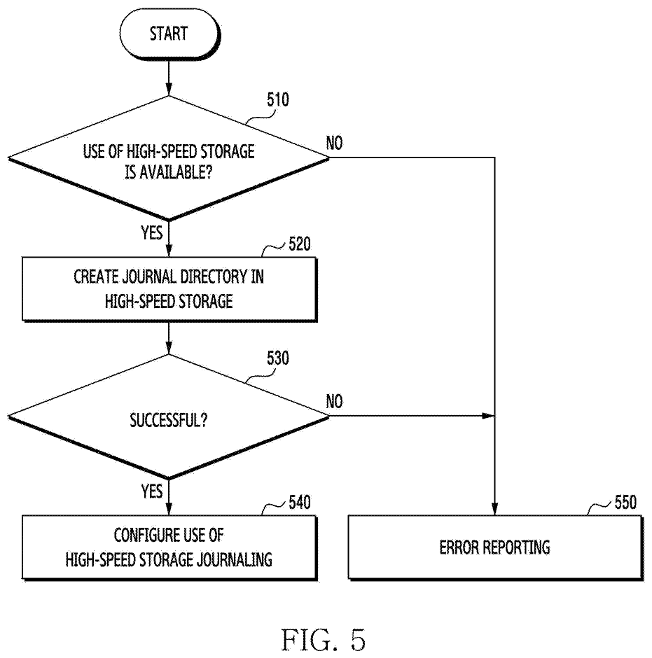

FIG. 5 is a flowchart illustrating a method for configuring high-speed storage journaling according to an embodiment of the disclosure. FIG. 5 illustrates operations for configuring journaling using a second storage 334, which is a high-speed storage, in an electronic device 301 according to an embodiment.

The operations illustrated in FIG. 5 may be performed sequentially, but are not necessarily performed sequentially. For example, an order of the respective operations may be changed, and at least two operations may be performed in parallel or substantially simultaneously. Optionally or alternatively, some of the operations illustrated in FIG. 5 may be omitted.

The operations of FIG. 5, for example, operation 510, may be initiated by an SQL statement (e.g., a PRAGMA command) specified in an application 410 or a call of an API.

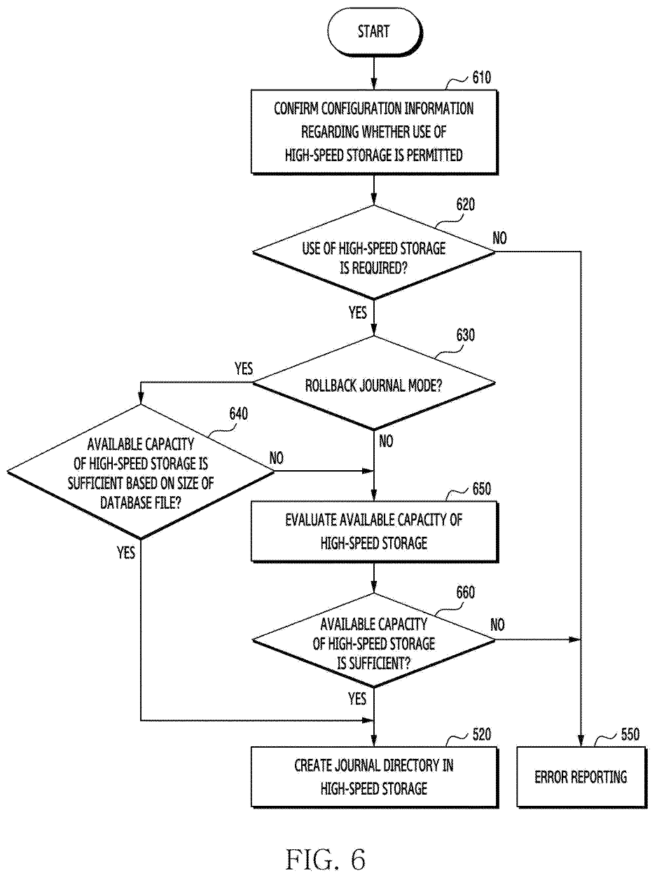

In operation 510, a processor 320 may confirm whether use of a high-speed storage is available. For example, the processor 320 may confirm whether use of a second storage 334 from among a first storage 332 and the second storage 334 is available. Operation 510 is described with reference to FIG. 6. When it is confirmed in operation 510 that use of the high-speed storage is available, operation 520 may be performed. Otherwise, operation 550 may be performed.

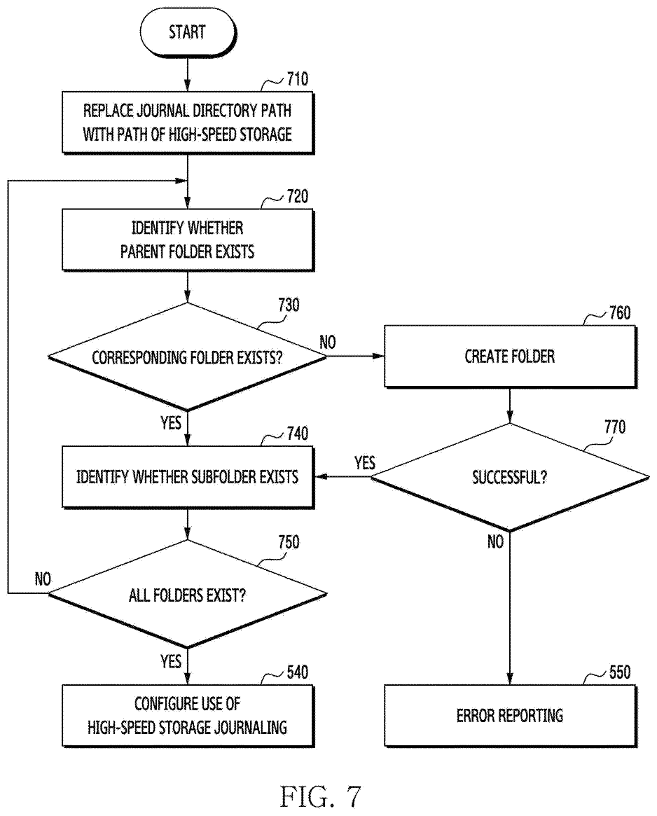

In operation 520, the processor 320 may create a journal directory of the high-speed storage. For example, the processor 320 may create a journal directory (or a directory path) in the second storage 334 in which a journal file 450 is stored. Operation 520 is described with reference to FIG. 7. When creation of the journal directory of the high-speed storage is successful in operation 520 (operation 530: YES), operation 540 may be performed. In contrast, when creation of the journal directory of the high-speed storage fails in operation 520 (operation 530: NO), operation 550 may be performed.

In operation 540, the processor 320 may configure use of high-speed storage journaling. For example, the processor 320 may set a setting value indicating whether journaling using the second storage 334 is enabled. The setting value may be stored in an in-memory form. For example, the setting value may be stored in volatile memory (e.g., the volatile memory 132 of FIG. 1) of memory 330.

In operation 550, the processor 320 may perform error reporting. As a non-limiting example, the error reporting may include various information, such as an operation during which an error occurred, a type of the error, and a performance process and a result of the operation in which the error occurred.

FIG. 6 is a flowchart illustrating a method for determining whether use of a high-speed storage is permitted according to an embodiment of the disclosure.

Operations illustrated in FIG. 6 may include detailed operations of operation 510 of FIG. 5. The operations illustrated in FIG. 6 may be performed sequentially, but are not necessarily performed sequentially. For example, an order of the respective operations may be changed, and at least two operations may be performed in parallel or substantially simultaneously. Optionally or alternatively, some of the operations illustrated in FIG. 6 may be omitted.

Referring to FIG. 6, in operation 610, a processor 320 may confirm configuration information regarding whether use of a high-speed storage is permitted. For example, the processor 320 may, using configuration information related to a database file 440 (or a database) on whether use of a second storage 334 is permitted, confirm whether managing the database file 440 using the second storage 334 from among a first storage 332 and the second storage 334 is permitted. For example, whether use of the high-speed storage is permitted may be configured through a change in library code of a database manager 420. As another example, whether use of the high-speed storage is permitted may be configured through a build environment configuration of a library of the database manager 420. In an embodiment of the disclosure, the configuration information regarding whether use of the high-speed storage is permitted may be stored in an in-memory form. For example, the configuration information regarding whether use of the high-speed storage is permitted may be stored in volatile memory (e.g., the volatile memory 132 of FIG. 1) of memory 330.

In operation 620, the processor 320 may determine whether use of the high-speed storage is required. For example, the processor 320 may determine whether use of the high-speed storage is required by using the configuration information regarding whether use of the high-speed storage is permitted confirmed in operation 610. When it is determined that use of the high-speed storage is required (operation 620: YES), operation 630 may be performed, otherwise, operation 550 of FIG. 5 may be performed.

In operation 630, the processor 320 may confirm whether a journal mode of the database file 440 (or the database) is a rollback journal mode. For example, the processor 320 may transmit a command for confirming a journal mode of the database from an application 410 to the database manager 420. Through this, the processor 320 may confirm whether the journal mode of the database is the rollback journal mode. In operation 630, when it is confirmed that the journal mode of the database file 440 is the rollback journal mode (operation 630: YES), operation 640 may be performed. In operation 630, when it is confirmed that the journal mode of the database file 440 is not the rollback journal mode (operation 630: NO), operation 650 may be performed. For example, when it is confirmed in operation 630 that the journal mode of the database file 440 is a WAL mode rather than the rollback journal mode (operation 630: NO), operation 650 may be performed.

In operation 640, the processor 320 may determine whether available capacity of the high-speed storage is sufficient based on a size of the database file. For example, the processor 320 may determine whether available capacity of the second storage 334 exceeds the size of the database file 440. When the available capacity of the second storage 334 exceeds the size of the database file 440, the processor 320 may determine that the available capacity of the high-speed storage is sufficient. When the available capacity of the second storage 334 does not exceed the size of the database file 440, the processor 320 may determine that the available capacity of the high-speed storage is insufficient. In operation 640, when it is determined that the available capacity of the high-speed storage is sufficient (operation 640: YES), operation 520 of FIG. 5 may be performed. Otherwise (operation 640: NO), operation 650 may be performed. The available capacity of the storage may be a capacity that is unoccupied by files and folders.

In operation 650, the processor 320 may evaluate the available capacity of the high-speed storage. For example, the processor 320 may determine whether a ratio of the available capacity to a total capacity of the second storage 334 exceeds a threshold. For example, the threshold may be 10%, but is not limited thereto.

In operation 660, the processor 320 may determine whether the available capacity of the high-speed storage is sufficient. For example, when it is determined in operation 650 that the available capacity of the second storage 334 exceeds the threshold, the processor 320 may determine that the available capacity of the high-speed storage is sufficient. When it is determined in operation 650 that the available capacity of the second storage 334 does not exceed the threshold, the processor 320 may determine that the available capacity of the high-speed storage is insufficient.

In operation 660, when it is determined that the available capacity of the high-speed storage is sufficient (operation 660: YES), operation 520 of FIG. 5 may be performed, otherwise (operation 660: NO), operation 550 of FIG. 5 may be performed. For example, when it is determined in operation 660 that the available capacity of the high-speed storage is insufficient (operation 660: NO), operation 550 of FIG. 5 may be performed.

FIG. 7 is a flowchart illustrating a method for creating a journal directory of a high-speed storage according to an embodiment of the disclosure.

Operations illustrated in FIG. 7 may include detailed operations of operation 520 of FIG. 5. The operations illustrated in FIG. 7 may be performed sequentially, but are not necessarily performed sequentially. For example, an order of the respective operations may be changed, and at least two operations may be performed in parallel or substantially simultaneously. Optionally or alternatively, some of the operations illustrated in FIG. 7 may be omitted.

Referring to FIG. 7, in operation 710, a processor 320 may replace a journal directory path with a path of the high-speed storage. For example, the processor 320 may replace (or change) the journal directory path where a database file 440 is stored from a path of a first storage 332 with a path of a second storage 334. For example, the processor 320 may directly specify the path of the second storage 334 and store the specified path as the journal directory path of the database file 440 (or the database) in memory 330 (e.g., the non-volatile memory 134 of FIG. 1). As another example, the processor 320 may identify a file system partition of the first storage 332 currently used as the journal directory path, and a file system partition of the second storage 334. The processor 320 may replace a partition of the first storage 332 of the journal directory path of the database file 440 with a partition of the second storage 334. For example, when a/data partition is a partition using the first storage 332 and a/fast partition is a partition using the second storage 334, the journal directory path may be replaced from /data/data/com.example.package/databases, which is a path of the first storage 332, to /fast/data/com.example.package/databases, which is a path in the second storage 334.

In operation 720, the processor 320 may identify whether a parent folder exists. For example, the processor 320 may identify, starting from the parent folder, whether folders in the second storage 334 corresponding to the journal directory path set in operation 710 exist.

In operation 720, when it is identified that a folder corresponding to the path of the journal directory exists (operation 730: YES), operation 740 may be performed, otherwise, operation 760 may be performed.

In operation 740, the processor 320 may identify whether a subfolder exists. For example, the processor 320 may identify whether a subfolder of the folder identified as existing in operation 720 or a subfolder of a folder created in operation 760 exists in the second storage 334.

In operation 750, the processor 320 may identify whether all folders exist. For example, the processor 320 may identify whether all folders corresponding to the journal directory path set in operation 710 exist in the second storage 334. When it is identified in operation 750 that all folders exist in the second storage 334, operation 540 of FIG. 5 may be performed, otherwise, operation 720 may be performed. In operation 720 performed after operation 750, the processor 320 may identify whether a highest-level folder among folders identified as not existing in operation 750 exists in the second storage 334.

In operation 760, the processor 320 may create a folder. For example, the processor 320 may create a folder identified as not existing in operation 730 in the second storage 334. For example, a format of a database path of an application 410 may be /data/data/[package path]/databases/[database file name]. In this case, only an application and a service having a user ID corresponding to the [package path] may access the database path. For example, the database path of the application 410 may be /data/data/com.example.package/databases/test.db, and a path of /data/data/com.example.pacakge and subfolders and files thereof may all be accessed only by the user ID of com.example.package. By using this, the processor 320 may create a folder in the second storage 334 at a path corresponding to the journal directory path of the first storage 332 so as to have the same authority (e.g., user ID) as the application 410.

When creation of the folder is successful in operation 760 (operation 770: YES), operation 740 may be performed. When creation of the folder fails in operation 760 (operation 770: NO), operation 550 of FIG. 5 may be performed.

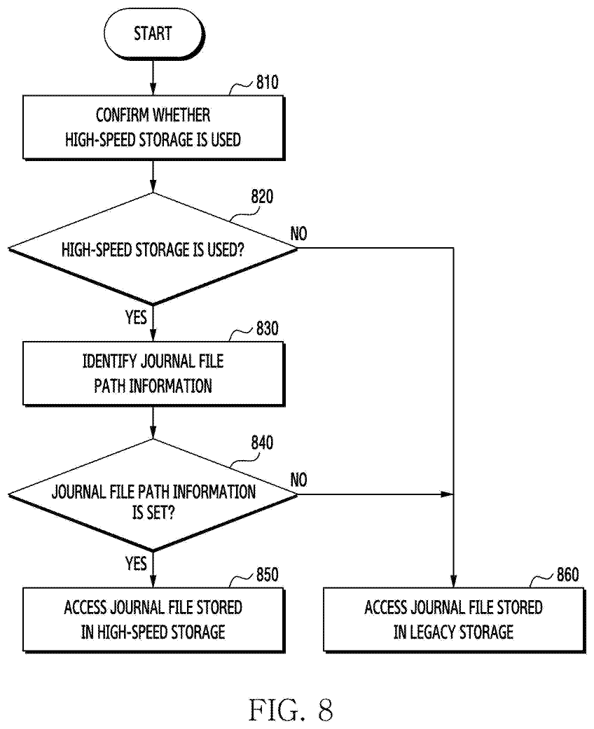

FIG. 8 is a flowchart illustrating a method for identifying journal file path information according to an embodiment of the disclosure.

Operations illustrated in FIG. 8 may be performed sequentially, but are not necessarily performed sequentially. For example, an order of the respective operations may be changed, and at least two operations may be performed in parallel or substantially simultaneously. Optionally or alternatively, some of the operations illustrated in FIG. 8 may be omitted.

When a problem occurs while journal information is being written to a second storage 334, a rollback operation to stop a current transaction and restore data of a database file 440 to a previous state may be required. To perform the rollback operation, information about a journal file 450 may be required. Due to reasons, such as a process kill, path information where the journal file 450 is stored may not exist in memory 330 of an electronic device 301. FIG. 8 illustrates a method for identifying journal file path information to perform the rollback operation.

Referring to FIG. 8, in operation 810, a processor 320 may confirm whether a high-speed storage is used. Regarding operation 810, descriptions of the operations of FIG. 6 may be applied in a substantially same or in a corresponding manner.

In operation 810, when it is confirmed that the high-speed storage is used (operation 820: YES), operation 830 may be performed. For example, when it is determined as ‘YES’ in operation 620 of FIG. 6, operation 830 may be performed.

In operation 810, when it is confirmed that the high-speed storage is not used (operation 820: NO), operation 860 may be performed. For example, when it is determined as ‘NO’ in operation 620 of FIG. 6, operation 860 may be performed.

In operation 830, the processor 320 may identify journal file path information. For example, the processor 320 may identify whether an xattr of the database file 440 or another file in which journal file path information is stored (e.g., test.db-journalpath) exists, and may identify a journal file path of the database file 440 through the corresponding file.

In operation 840, the processor 320 may confirm whether the journal file path information is set. For example, when the journal file path of the database file 440 is identified in operation 830 (operation 840: YES), operation 850 may be performed. When the journal file path of the database file 440 is not identified in operation 830 (operation 840: NO), operation 860 may be performed. In operation 850, the processor 320 may access a journal file stored in the high-speed storage. For example, the processor 320 may access the journal file 450 stored in the second storage 334 using the journal file path of the database file 440 identified in operation 830.

In operation 860, the processor 320 may access a journal file stored in a legacy storage. For example, the processor 320 may access a journal file stored in the first storage 332 using information about a path of the first storage 332 where the database file 440 is stored.

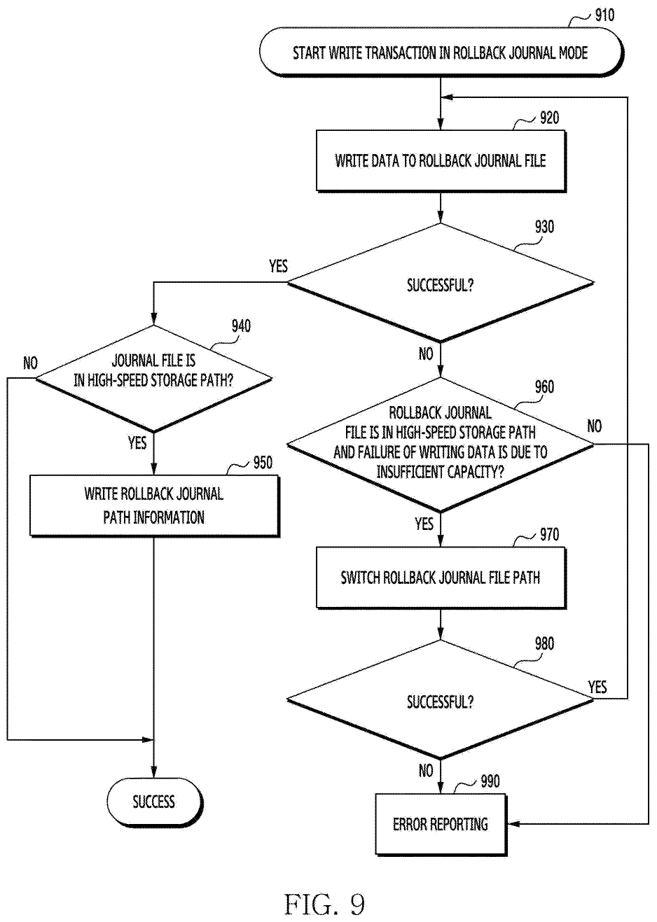

FIG. 9 is a flowchart illustrating a method for processing a transaction using a high-speed storage in a rollback journal mode according to an embodiment of the disclosure.

Operations illustrated in FIG. 9 may be performed sequentially, but are not necessarily performed sequentially. For example, an order of the respective operations may be changed, and at least two operations may be performed in parallel or substantially simultaneously. Optionally or alternatively, some of the operations illustrated in FIG. 9 may be omitted.

Referring to FIG. 9, in operation 910, a processor 320 may start a write transaction in the rollback journal mode. For example, the processor 320 may perform a write transaction on data of a database file 440 in the rollback journal mode according to a request from an application 410.

In operation 920, the processor 320 may write data to a rollback journal file. For example, after high-speed storage journaling is configured by performing operations of FIG. 5, the processor 320 may create a journal file 450 including original data of the database file 440 in a second storage 334, or may write the original data of the database file 440 to the journal file 450 stored in the second storage 334. Alternatively, when high-speed storage journaling is not configured, the processor 320 may create a journal file 450 including the original data of the database file 440 in a first storage 332, or may write the original data of the database file 440 to the journal file 450 stored in the first storage 332.

In operation 930, the processor 320 may confirm whether writing data to the rollback journal file is successful. When writing data to the rollback journal file is successful in operation 920 (operation 930: YES), operation 940 may be performed. Otherwise, when writing data to the rollback journal file fails in operation 920 (operation 930: NO), operation 960 may be performed.

In operation 940, the processor 320 may confirm whether the journal file 450 is in a high-speed storage path. For example, the processor 320 may confirm whether a path where the journal file 450 is stored is a path of the second storage 334. When it is confirmed in operation 940 that the journal file 450 is in the high-speed storage path (operation 940: YES), operation 950 may be performed. Otherwise (operation 940: NO), execution of the operation may be terminated.

In operation 950, the processor 320 may write rollback journal file path information. For example, the processor 320 may record a path where the journal file 450 is stored in an xattr of the database file 440 or in another file (e.g., test.db-journalpath) in which rollback journal file path information is stored. Information about the path where the journal file 450 is stored, recorded in operation 950, may be used to identify journal file path information in operation 830 of FIG. 8.

When operation 940 is determined as ‘NO’ or after operation 950 is performed, the processor 320 may perform a commit operation, and at commit time, the journal file 450 stored in the first storage 332 or the second storage 334 may be processed according to a setting of the rollback journal mode (e.g., delete, truncate, or persist).

In operation 960, the processor 320 may determine whether the rollback journal file is in the high-speed storage path and whether failure of writing data is due to an insufficient capacity error. For example, when the journal file 450 is in a path of the second storage 334 and an ENOSPC error occurs in a write system call, the processor 320 may determine that the failure of writing data is due to lack of available capacity of the second storage 334. In operation 960, when it is determined that the rollback journal file is in the high-speed storage path and the failure of writing data is due to the insufficient capacity error (operation 960: YES), operation 970 may be performed. Otherwise (operation 960: NO), operation 990 may be performed.

In operation 970, the processor 320 may switch the rollback journal file path. For example, the processor 320 may change the path where the journal file 450 according to a transaction of the database file 440 is stored (e.g., the journal directory path of operation 710 of FIG. 7) from the path in the second storage 334 to the path in the first storage 332. Although not illustrated, before switching the path of the rollback journal file in operation 970, the processor 320 may copy the journal file stored in the path of the second storage 334 to the path of the first storage 332. When the copying operation is successful, operation 970 may be performed, otherwise, operation 990 may be performed. When operation 970 is successful (operation 980: YES), the processor 320 may delete the journal file copied to the path of the first storage 332.

When switching of the rollback journal file path is successful in operation 970 (operation 980: YES), the processor 320 may perform operation 920. Otherwise, when switching of the rollback journal file path fails in operation 970 (operation 980: NO), the processor 320 may perform operation 990.

In operation 990, the processor 320 may perform error reporting. Regarding operation 990, the descriptions provided with reference to operation 550 of FIG. 5 may be applied in a substantially same manner.

In an embodiment of the disclosure, when an error does not occur while writing an original page to the rollback journal file (e.g., operation 930: YES), operations may be performed in the same manner as a rollback journal mode of the related art, and at commit time when all operations are completed, the journal file may be processed according to the rollback journal mode (e.g., delete, truncate, persist, and the like). When an error occurs while writing the original page to the rollback journal file (e.g., operation 930: NO), it may be confirmed whether the error is caused by insufficient capacity, as in operation 960.

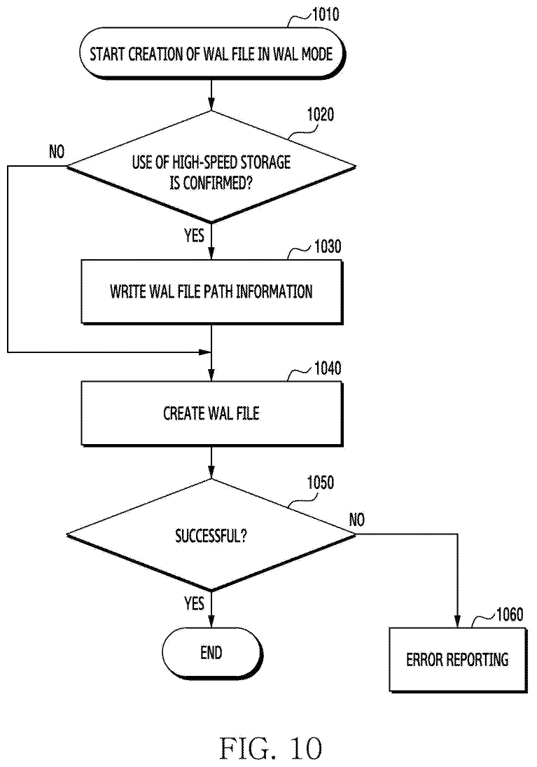

FIG. 10 is a flowchart illustrating a method for creating a journal file in a WAL mode according to an embodiment of the disclosure.

Operations illustrated in FIG. 10 may be performed sequentially, but are not necessarily performed sequentially. For example, an order of the respective operations may be changed, and at least two operations may be performed in parallel or substantially simultaneously. Optionally or alternatively, some of the operations illustrated in FIG. 10 may be omitted.

Referring to FIG. 10, in operation 1010, a processor 320 may start creation of a journal file in a WAL mode (e.g., a WAL file). For example, the processor 320 may start creation of the WAL file in the WAL mode according to a request from an application 410 to connect to or open a database file 440.

In operation 1020, the processor 320 may confirm whether a high-speed storage (e.g., a second storage 334) is in use. For example, the processor 320 may confirm whether the second storage 334 is used by checking a flag (or a setting value) indicating whether the second storage 334 is enabled, which was stored in operation 540 of FIG. 5. For example, when the setting value (e.g., ‘1’) indicates activation of the second storage 334, the processor 320 may confirm that the high-speed storage is in use, otherwise (e.g., when the setting value is ‘0’), the processor 320 may confirm that the high-speed storage is not in use.

In operation 1020, when it is confirmed that the high-speed storage is in use (operation 1020: YES), operation 1030 may be performed, otherwise (operation 1020: NO), operation 1040 may be performed.

In operation 1030, the processor 320 may write WAL file path information. Descriptions of operation 1030 may be applied in a substantially same or in a corresponding manner to descriptions provided with reference to operation 950 of FIG. 9. The WAL file path information written in operation 1030 may be identified through operation 830 of FIG. 8.

In operation 1040, the processor 320 may create a WAL file. For example, when it is confirmed in operation 1020 that the high-speed storage is in use, the processor 320 may create a journal file 450 in the second storage 334. As another example, when it is confirmed in operation 1020 that the high-speed storage is not in use, the processor 320 may create the journal file 450 in a first storage 332.

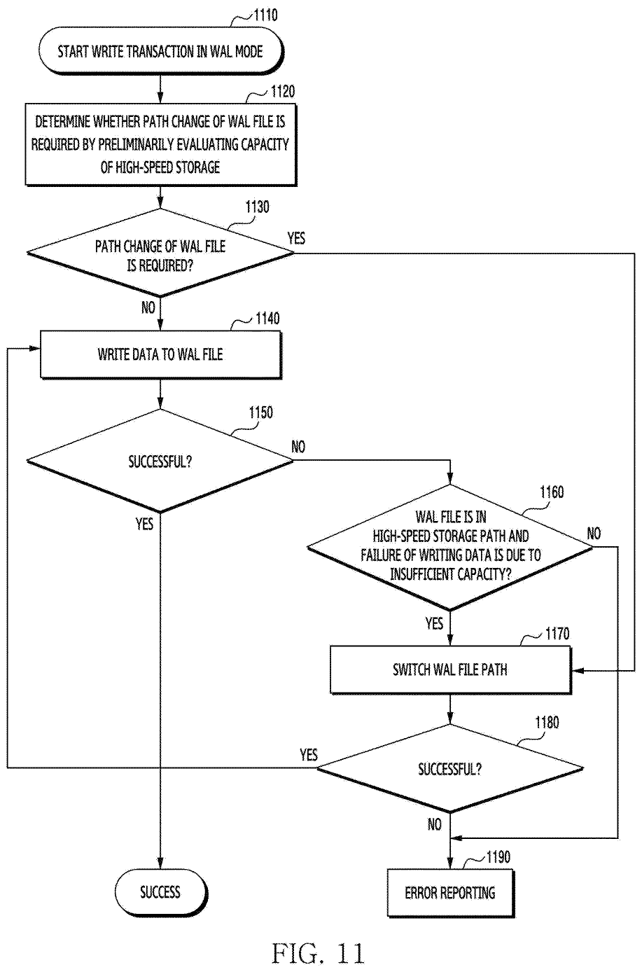

When creation of the WAL file is successful in operation 1040 (operation 1050: YES), execution of the operation may be completed. Unlike the illustration, when creation of the WAL file is successful in operation 1040 (operation 1050: YES), operation 1110 of FIG. 11 may be performed. When creation of the WAL file fails in operation 1040 (operation 1050: NO), operation 1060 may be performed.

In operation 1060, the processor 320 may perform error reporting. Regarding operation 1060, descriptions provided with reference to operation 990 of FIG. 9 may be applied in a substantially same manner.

FIG. 11 is a flowchart illustrating a method for processing a transaction using a high-speed storage in a WAL mode according to an embodiment of the disclosure.

In an embodiment of the disclosure, the WAL mode may write modified page data, rather than original data, to a WAL file. For example, at commit time when a transaction is completed or at reclaim time when a page cache is flushed to secure memory, a modified page may be written to the WAL file. As described below, when a capacity of the high-speed storage is insufficient, a path of the WAL file may be changed to a legacy storage, and then the WAL file may be written to the legacy storage.

Operations illustrated in FIG. 11 may be performed sequentially, but are not necessarily performed sequentially. For example, an order of the respective operations may be changed, and at least two operations may be performed in parallel or substantially simultaneously. Optionally or alternatively, some of the operations illustrated in FIG. 11 may be omitted.

Referring to FIG. 11, in operation 1110, a processor 320 may start a write transaction in the WAL mode. For example, the processor 320 may perform a write transaction on a database file 440 in the WAL mode according to a request from an application 410.

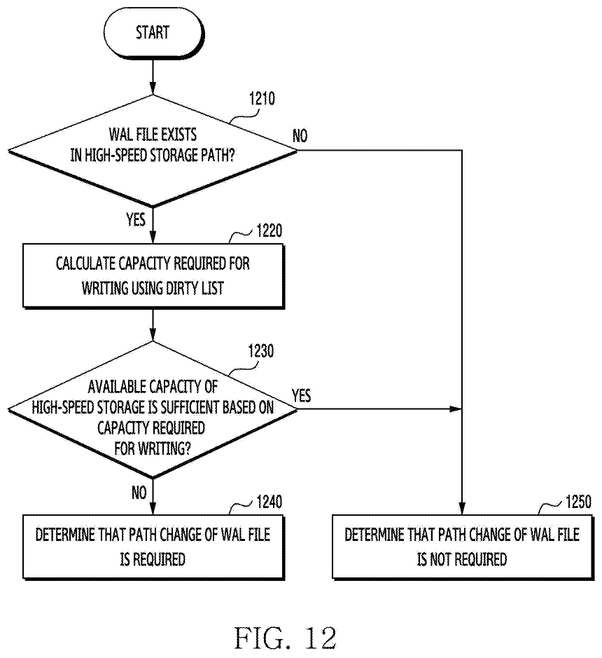

In operation 1120, the processor 320 may determine whether a path change of the WAL file is required by preliminarily evaluating the capacity of the high-speed storage. Operation 1120 is described with reference to FIG. 12. When it is determined in operation 1120 that the path change of the WAL file is not required (operation 1130: NO), operation 1140 may be performed. Otherwise, when it is determined in operation 1120 that the path change of the WAL file is required (operation 1130: YES), operation 1170 may be performed.

In operation 1140, the processor 320 may write data to the WAL file. For example, the processor 320 may write data according to a transaction to a journal file 450 stored in a second storage 334. The journal file 450 may be created in the second storage 334 by performing operation 1040 of FIG. 10.

When writing data to the WAL file fails in operation 1140 (operation 1150: NO), operation 1160 may be performed. Otherwise, when writing data to the WAL file is successful in operation 1140 (operation 1150: YES), the write transaction operation may be completed.

In operation 1160, the processor 320 may determine whether the WAL file is in a high-speed storage path (e.g., a path of the second storage 334) and whether failure of writing data is due to insufficient capacity. Regarding operation 1160, descriptions of operation 960 of FIG. 9 may be applied in a substantially same or in a corresponding manner. In operation 1160, when it is determined that the WAL file is in the high-speed storage path and the failure of writing data is due to an insufficient capacity error (operation 1160: YES), operation 1170 may be performed. Otherwise (operation 1160: NO), operation 1190 may be performed.

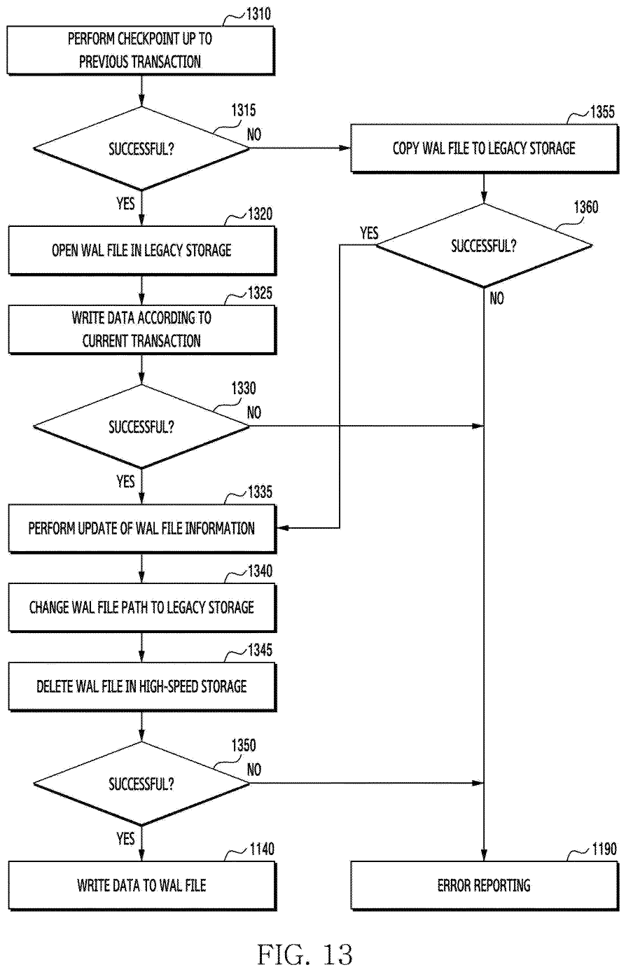

In operation 1170, the processor 320 may switch the WAL file path. For example, the processor 320 may change the path where the journal file 450, which records changes to data according to a transaction of the database file 440, is stored (e.g., the journal directory path of operation 710 of FIG. 7) from the path in the second storage 334 to the path in the first storage 332. Operation 1170 is described with reference to FIG. 13.

When switching of the WAL file path is successful in operation 1170 (operation 1180: YES), the processor 320 may perform operation 1140. Otherwise, when switching of the WAL file path fails in operation 1170 (operation 1180: NO), the processor 320 may perform operation 1190.

In operation 1190, the processor 320 may perform error reporting. Regarding operation 1190, descriptions provided with reference to operation 990 of FIG. 9 may be applied in a substantially same manner.

In operation 1140 performed after it is determined as ‘YES’ in operation 1108, the processor 320 may write data according to a transaction to the journal file 450 in the path changed in operation 1170 (e.g., the path in the first storage 332).

FIG. 12 is a flowchart illustrating a method for determining whether a path change of a journal file is required by preliminarily evaluating a capacity of a high-speed storage according to an embodiment of the disclosure.

Operations illustrated in FIG. 12 may include detailed operations of operation 1120 of FIG. 11. The operations illustrated in FIG. 12 may be performed sequentially, but are not necessarily performed sequentially. For example, an order of the respective operations may be changed, and at least two operations may be performed in parallel or substantially simultaneously. Optionally or alternatively, some of the operations illustrated in FIG. 12 may be omitted.

Referring to FIG. 12, in operation 1210, a processor 320 may confirm whether a WAL file exists in a high-speed storage path. For example, since a WAL mode writes modified page data to the WAL file at a time of transaction completion or a time of reclaim of a cache, the processor 320 may confirm whether the WAL file exists or the number of pages to be written before writing the modified page data. For example, the processor 320 may confirm whether a journal file 450 exists in a second storage 334. When it is confirmed that the WAL file exists in the high-speed storage path (operation 1210: YES), the processor 320 may perform operation 1220, otherwise, the processor 320 may determine that the path change of the WAL file is not required (operation 1130: NO).

In operation 1220, the processor 320 may calculate a capacity required for writing using a dirty list. For example, the processor 320 may identify the number of pages to be written by parsing data of the dirty list. The processor 320 may calculate a size of each page. For example, the size of each page may be a sum of a size of one WAL frame header (e.g., 24 bytes) and a size of a page (e.g., 4096 bytes). For example, when the WAL file is written for the first time, an additional capacity corresponding to a WAL file header (e.g., 32 bytes) may be required. The processor 320 may calculate the required capacity for writing by multiplying the size of each page by the number of pages.

In operation 1230, the processor 320 may determine whether available capacity of the high-speed storage is sufficient based on the capacity required for writing. For example, when available capacity of the second storage 334 exceeds the capacity required for writing calculated in operation 1220, the processor 320 may determine that the available capacity of the high-speed storage is sufficient (operation 1230: YES). When the available capacity of the second storage 334 does not exceed the capacity required for writing calculated in operation 1220, the processor 320 may determine that the available capacity of the high-speed storage is insufficient (operation 1230: NO). In operation 1230, when it is determined that the available capacity of the storage is sufficient (operation 1230: YES), operation 1250 may be performed. In operation 1250, the processor 320 may determine that the path change of the WAL file is not required (operation 1130: NO).

When it is determined in operation 1230 that the available capacity of the storage is insufficient (operation 1230: NO), operation 1240 may be performed. In operation 1240, the processor 320 may determine that the path change of the WAL file is required (operation 1130: YES).

FIG. 13 is a flowchart illustrating a method for changing a journal file path in a WAL mode according to an embodiment of the disclosure.

Operations illustrated in FIG. 13 may include detailed operations of operation 1170 of FIG. 11. The operations illustrated in FIG. 13 may be performed sequentially, but are not necessarily performed sequentially. For example, an order of the respective operations may be changed, and at least two operations may be performed in parallel or substantially simultaneously. Optionally or alternatively, some of the operations illustrated in FIG. 13 may be omitted.

Referring to FIG. 13, in operation 1310, a processor 320 may perform a checkpoint up to a previous transaction. For example, the processor 320 may perform a checkpoint up to a transaction prior to the transaction detected in operation 1110 of FIG. 11. Data up to a transaction prior to a current transaction may already be stored in a WAL file. According to an embodiment of the disclosure, since the processor 320 may check data up to a previous transaction, it may perform a WAL checkpoint on modified pages in a database up to the corresponding transaction.

When the performance of the checkpoint is successful in operation 1310 (operation 1315: YES), operation 1320 may be performed, otherwise (operation 1315: NO), operation 1355 may be performed. For example, when a read transaction is in progress, a checkpoint lock may not be obtained, and thus the performance of the checkpoint may fail.

In operation 1320, the processor 320 may open a WAL file in a legacy storage. For example, the processor 320 may open a journal file 450 stored in a first storage 332.

In operation 1325, the processor 320 may write data according to the current transaction. For example, the processor 320 may record data according to the transaction of operation 1110 of FIG. 11 in the journal file 450 opened in operation 1320.

When writing data according to the current transaction is successful in operation 1325 (operation 1330: YES), operation 1335 may be performed, otherwise (operation 1330: NO), operation 1190 of FIG. 11 may be performed.

In operation 1335, the processor 320 may perform an update of WAL journal file information. For example, the processor 320 may update the WAL journal file information to indicate that the first storage 332, not the second storage 334, is being used.

In operation 1340, the processor 320 may change the WAL file path to the legacy storage (e.g., the first storage 332). Through this, changes to data according to a transaction after a current timing may be stored in the WAL file in the first storage 332.

In operation 1345, the processor 320 may delete the WAL file in a high-speed storage. For example, the processor 320 may delete the journal file 450 stored in the second storage 334. When deletion of the WAL file is successful in operation 1345 (operation 1350: YES), operation 1140 may be performed, otherwise (operation 1350: NO), operation 1190 of FIG. 11 may be performed.

In operation 1355, the processor 320 may copy the WAL file to the legacy storage. When copying of the WAL file is successful in operation 1355 (operation 1360: YES), operation 1335 may be performed. Otherwise (operation 1360: NO), operation 1190 of FIG. 11 may be performed.

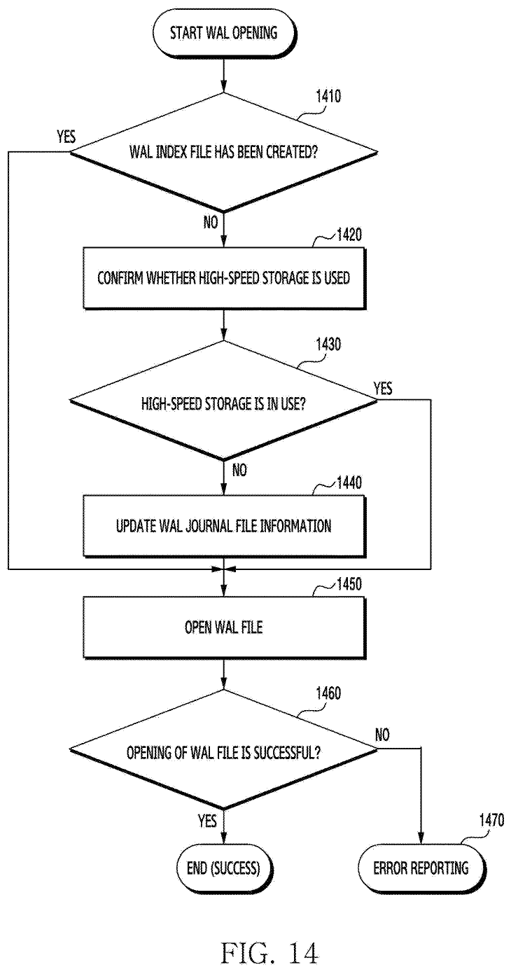

FIG. 14 is a flowchart illustrating a method for updating journal information in a WAL mode according to an embodiment of the disclosure.

Operations illustrated in FIG. 14 may be performed sequentially, but are not necessarily performed sequentially. For example, an order of the respective operations may be changed, and at least two operations may be performed in parallel or substantially simultaneously. Optionally or alternatively, some of the operations illustrated in FIG. 14 may be omitted.

In a rollback journal mode, since original data is written to a journal file, it may be necessary to write a history of a path of the journal file at least at commit time. In contrast, in a WAL mode, since modified new data exists in a WAL file and the WAL file should be accessed in a read transaction, information about a WAL file path may need to be stored in advance. Accordingly, unlike the rollback journal mode, the WAL mode may require an update of a location of a WAL journal file at a time when the WAL file is first opened (a time when a WAL index file is created). Hereinafter, operations for updating whether the WAL journal file exists at a location are described with reference to FIG. 14.

In operation 1410, a processor 320 may determine whether a WAL index file has been created. An index of the WAL file may be stored in the WAL index file. The WAL index file may provide an index for efficiently searching records of database changes stored in the WAL file. The WAL index file may be stored in the same path as a database file. The processor 320 may confirm whether the WAL index file exists in a path of the database file. For example, when the WAL file is opened for the first time, the WAL index file may not have been created, otherwise, the WAL index file may have been created. When it is determined in operation 1410 that the WAL index file has been created (operation 1410: YES), operation 1450 may be performed, otherwise, operation 1420 may be performed.

In operation 1420, the processor 320 may confirm whether a high-speed storage is used. In operation 1420, the processor 320 may confirm whether the high-speed storage (e.g., a second storage 334) is in use. For example, the processor 320 may confirm whether the second storage 334 is used by checking a flag (or a setting value) indicating whether the second storage 334 is enabled, which was stored through operation 540 of FIG. 5. For example, when the setting value (e.g., ‘1’) indicates activation of the second storage 334, the processor 320 may confirm that the high-speed storage is in use, otherwise (e.g., when the setting value is ‘0’), the processor 320 may confirm that the high-speed storage is not in use. In operation 1420, when it is confirmed that the high-speed storage is in use (operation 1430: YES), operation 1440 may be performed, otherwise (operation 1430: NO), operation 1450 may be performed.

In operation 1450, the processor 320 may update WAL journal file information. For example, the processor 320 may update a path of a journal file 450 recorded in an xattr of a database file 440 or in another file (e.g., test.db-journalpath) in which rollback journal file path information is stored, to a path of the second storage 334, which is the high-speed storage.

In operation 1450, the processor 320 may open the WAL file. For example, when it is determined as ‘YES’ in operation 1410, the processor 320 may open a previously stored WAL file. For example, when it is determined as ‘NO’ in operation 1430, the processor 320 may create a WAL file in a path of the first storage 332, which is a legacy storage. For example, after performing operation 1440, the processor 320 may create a WAL file in a path of the second storage 334, which is the high-speed storage. When opening of the WAL file is successful in operation 1450 (operation 1460: YES), the operation may be completed, otherwise (operation 1460: NO), operation 1470 may be performed.

In operation 1470, the processor 320 may perform error reporting. Regarding operation 1470, descriptions provided with reference to operation 990 of FIG. 9 may be applied in a substantially same manner.

According to an embodiment of the disclosure, an electronic device (e.g., the electronic device 301 of FIG. 4) may comprise memory (e.g., the memory 330 of FIG. 3) including a first storage (e.g., the first storage 332 of FIG. 4) and a second storage (e.g., the second storage 334 of FIG. 4) having a faster access speed than the first storage (e.g., the first storage 332 of FIG. 4), and a processor (e.g., the processor 320 of FIG. 3). Instructions stored in the memory, when executed by the processor, may cause the electronic device to verify, using information related to a database stored in the memory, whether authority to perform read and write operations on the database using the second storage from among the first storage or the second storage is granted. The instructions stored in the memory, when executed by the processor, may cause the electronic device to, based on verifying that the authority is granted, execute a function of creating journal information in the second storage, the journal information related to the database stored in the first storage. The instructions stored in the memory, when executed by the processor, may cause the electronic device to, based on the execution of the function, update the journal information stored in the second storage according to a transaction related to the database based on the journal information stored in the second storage. The instructions stored in the memory, when executed by the processor, may cause the electronic device to, based on the execution of the function, create the journal information in the first storage based on identifying that the journal information is not created in the second storage by the execution of the function.

In an embodiment of the disclosure, the instructions stored in the memory, when executed by the processor, may cause the electronic device to, in response to verifying that the authority to perform write and read operations on the database using the second storage is granted, determine whether available capacity of the second storage satisfies a specified criterion. The instructions stored in the memory, when executed by the processor, may cause the electronic device to, in a case of determining that the available capacity of the second storage satisfies the specified criterion, set a path where the journal information related to the database is stored in the second storage.

In an embodiment of the disclosure, the instructions stored in the memory, when executed by the processor, may cause the electronic device to, based on identifying that the journal information is not created in the second storage by the execution of the function, set a path where the journal information is stored in the first storage for creating the journal information related to the database in the first storage.

In an embodiment of the disclosure, the instructions stored in the memory, when executed by the processor, may cause the electronic device to, in response to identifying that the journal information is created in the second storage by the execution of the function, confirm whether the path where the journal information is stored corresponds to the second storage. The instructions stored in the memory, when executed by the processor, may cause the electronic device to, in response to confirming that the path where the journal information is stored corresponds to the second storage, store, in the first storage, information about the path.

In an embodiment of the disclosure, the instructions stored in the memory, when executed by the processor, may cause the electronic device to, in response to verifying that the authority to perform write and read operations on the database using the second storage is granted, determine whether available capacity of the second storage satisfies a specified criterion. The instructions stored in the memory, when executed by the processor, may cause the electronic device to, in a case of determining that the available capacity of the second storage satisfies the specified criterion, create the journal information in the second storage and store information about a path where the journal information is stored in the first storage. The instructions stored in the memory, when executed by the processor, may cause the electronic device to, in a case of determining that the available capacity of the second storage does not satisfy the specified criterion, create the journal information in the first storage.

In an embodiment of the disclosure, the instructions stored in the memory, when executed by the processor, may cause the electronic device to, based on detecting a transaction related to the database, determine whether available capacity of the second storage exceeds a capacity of data according to the transaction. The instructions stored in the memory, when executed by the processor, may cause the electronic device to, based on determining that the available capacity of the second storage exceeds the capacity of the data according to the transaction, record the data according to the transaction in the journal information stored in the second storage.

In an embodiment of the disclosure, the instructions stored in the memory, when executed by the processor, may cause the electronic device to, based on determining that the available capacity of the second storage does not exceed the capacity of the data according to the transaction, modify the database according to data related to another transaction prior to the transaction, recorded in the journal information stored in the second storage. The instructions stored in the memory, when executed by the processor, may cause the electronic device to, based on confirming that the database is modified according to the data related to the another transaction prior to the transaction, record the data according to the transaction in other journal information related to the database and stored in the first storage. The instructions stored in the memory, when executed by the processor, may cause the electronic device to, based on confirming that the database is modified according to the data related to the another transaction prior to the transaction, change a path where the journal information related to the database is stored from the second storage to the first storage.

In an embodiment of the disclosure, the instructions stored in the memory, when executed by the processor, may cause the electronic device to, based on confirming that the database is not modified according to the data related to the another transaction prior to the transaction, store a copy of the journal information stored in the second storage in the first storage. The instructions stored in the memory, when executed by the processor, may cause the electronic device to, based on confirming that the database is not modified according to the data related to the another transaction prior to the transaction, change a path where the journal information related to the database is stored from the second storage to the first storage.

In an embodiment of the disclosure, the transaction for modifying data in the database may include a write transaction.

In an embodiment of the disclosure, the second storage may be mounted within the electronic device.

In an embodiment of the disclosure, the instructions stored in the memory, when executed by the processor, may cause the electronic device to confirm, using the information related to the database stored in the memory, whether storing the journal information related to the database in the second storage from among the first storage or the second storage is permitted.

In an embodiment of the disclosure, the journal information may include information about changes to the database by the transaction.

In an embodiment of the disclosure, a lack of available capacity of the second storage may cause failure to create the journal information in the second storage.

In an embodiment of the disclosure, an electronic device (e.g., the electronic device 301 of FIG. 4) may comprise memory (e.g., the memory 330 of FIG. 3) including a first storage area (e.g., the first storage 332 of FIG. 4) and a second storage area (e.g., the second storage 334 of FIG. 4) having a faster access speed than the first storage area, and a processor (e.g., the processor 320 of FIG. 3). Instructions stored in the memory, when executed by the processor, may cause the electronic device to confirm, using information related to a database stored in the memory, whether managing the database using the second storage area from among the first storage area or the second storage area is permitted. The instructions stored in the memory, when executed by the processor, may cause the electronic device to, based on confirming that managing the database using the second storage area is permitted, execute a function of creating journal information in the second storage area, the journal information related to the database stored in the first storage area. The instructions stored in the memory, when executed by the processor, may cause the electronic device to, based on the execution of the function, update the journal information stored in the second storage area according to a transaction related to the database based on the journal information stored in the second storage area. The instructions stored in the memory, when executed by the processor, may cause the electronic device to, based on the execution of the function, create the journal information in the first storage area based on identifying that the journal information is not created in the second storage area by the execution of the function.

In an embodiment of the disclosure, a method performed by an electronic device (e.g., the electronic device 301 of FIG. 4) including memory including a first storage (e.g., the first storage 332 of FIG. 4) and a second storage (e.g., the second storage 334 of FIG. 4) having a faster access speed than the first storage, may comprise confirming, using information related to a database stored in the memory, whether managing the database using the second storage from among the first storage or the second storage is permitted. The method may comprise, based on confirming that managing the database using the second storage is permitted, executing a function of creating journal information in the second storage, the journal information related to the database stored in the first storage. The method may comprise, based on the execution of the function, updating the journal information stored in the second storage according to a transaction related to the database based on the journal information stored in the second storage. The method may comprise, based on the execution of the function, creating the journal information in the first storage based on identifying that the journal information is not created in the second storage by the execution of the function.

In an embodiment of the disclosure, the method may comprise, in response to confirming that managing the database using the second storage is permitted, determining whether available capacity of the second storage satisfies a specified criterion. The method may comprise, in a case of determining that the available capacity of the second storage satisfies the specified criterion, setting a path where the journal information related to the database is stored in the second storage. The method may comprise, based on identifying that the journal information is not created in the second storage by the execution of the function, setting a path where the journal information is stored in the first storage for creating the journal information related to the database in the first storage.

In an embodiment of the disclosure, the method may comprise, in response to identifying that the journal information is created in the second storage by the execution of the function, confirming whether the path where the journal information is stored is a path in the second storage. The method may comprise, in response to confirming that the path where the journal information is stored is the path in the second storage, storing, in the first storage, information about the path in the second storage.

In an embodiment of the disclosure, the method may comprise, in response to confirming that managing the database using the second storage is permitted, determining whether available capacity of the second storage satisfies a specified criterion. The method may comprise, in a case of determining that the available capacity of the second storage satisfies the specified criterion, creating the journal information in the second storage and storing information about a path where the journal information is stored in the first storage. The method may comprise, in a case of determining that the available capacity of the second storage does not satisfy the specified criterion, creating the journal information in the first storage.

In an embodiment of the disclosure, the method may comprise, based on detecting a transaction related to the database, determining whether available capacity of the second storage exceeds a capacity of data according to the transaction. The method may comprise, based on determining that the available capacity of the second storage exceeds the capacity of the data according to the transaction, recording the data according to the transaction in the journal information stored in the second storage. The method may comprise, based on determining that the available capacity of the second storage does not exceed the capacity of the data according to the transaction, modifying the database according to data up to another transaction prior to the transaction, recorded in the journal information stored in the second storage. The method may comprise, based on confirming that the database is modified according to the data up to the another transaction prior to the transaction recorded in the journal information, recording the data according to the transaction in other journal information related to the database and stored in the first storage. The method may comprise changing a path where the journal information related to the database is stored from the second storage to the first storage.

In an embodiment of the disclosure, a computer-readable storage medium may store one or more programs. The one or more programs, when executed by a processor of an electronic device (e.g., the electronic device 301 of FIG. 4) including memory (e.g., the memory 330 of FIG. 3) including a first storage (e.g., the first storage 332 of FIG. 4) and a second storage (e.g., the second storage 334 of FIG. 4) having a faster access speed than the first storage, may cause the electronic device to confirm, using information related to a database stored in the memory, whether managing the database using the second storage from among the first storage or the second storage is permitted. The one or more programs, when executed by the processor, may cause the electronic device to, based on confirming that managing the database using the second storage is permitted, execute a function of creating journal information in the second storage, the journal information related to the database stored in the first storage. The one or more programs, when executed by the processor, may cause the electronic device to, based on the execution of the function, update the journal information stored in the second storage according to a transaction related to the database based on the journal information stored in the second storage. The one or more programs, when executed by the processor, may cause the electronic device to, based on identifying that the journal information is not created in the second storage by the execution of the function, create the journal information in the first storage.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory including a first storage and a second storage having a faster access speed than the first storage, the memory storing instructions; and
at least one processor, comprising processing circuitry,
wherein the instructions, when executed by the at least one processor individually or collectively, cause the electronic device to:
verify, using information related to a database stored in the memory, whether authority to perform read and write operations on the database using the second storage from among the first storage or the second storage is granted,
based on verifying that the authority is granted, execute a function of generating, in the second storage, journal information related to the database stored in the first storage, and
based on the execution of the function:
based on the journal information stored in the second storage, update the journal information stored in the second storage according to a transaction related to the database, and
based on identifying that the journal information is not generated in the second storage by the execution of the function, generate the journal information in the first storage.

2. The electronic device of claim 1, wherein the instructions, when executed by the at least one processor individually or collectively, further cause the electronic device to:
in response to verifying that the authority is granted, determine whether available capacity of the second storage satisfies a specified criterion, and
in a case of determining that the available capacity of the second storage satisfies the specified criterion, set a path where the journal information related to the database is stored in the second storage.

3. The electronic device of claim 1, wherein the instructions, when executed by the at least one processor individually or collectively, further cause the electronic device to:
based on identifying that the journal information is not generated in the second storage by the execution of the function, set a path where the journal information is stored in the first storage for generating the journal information related to the database in the first storage.

4. The electronic device of claim 3, wherein the instructions, when executed by the at least one processor individually or collectively, further cause the electronic device to:
in response to identifying that the journal information is generated in the second storage by the execution of the function, confirm whether the path where the journal information is stored corresponds to the second storage, and
in response to confirming that the path where the journal information is stored corresponds to the second storage, store, in the first storage, information about the path.

5. The electronic device of claim 1, wherein the instructions, when executed by the at least one processor individually or collectively, further cause the electronic device to:
in response to verifying that the authority is granted, determine whether available capacity of the second storage satisfies a specified criterion,
in a case of determining that the available capacity of the second storage satisfies the specified criterion, generate the journal information in the second storage and store information about a path where the journal information is stored in the first storage, and
in a case of determining that the available capacity of the second storage does not satisfy the specified criterion, generate the journal information in the first storage.

6. The electronic device of claim 5, wherein the instructions, when executed by the at least one processor individually or collectively, further cause the electronic device to:
based on detecting a transaction related to the database, determine whether available capacity of the second storage exceeds a capacity of data according to the transaction, and
based on determining that the available capacity of the second storage exceeds the capacity of the data according to the transaction, record the data according to the transaction in the journal information stored in the second storage.

7. The electronic device of claim 6, wherein the instructions, when executed by the at least one processor individually or collectively, further cause the electronic device to:
based on determining that the available capacity of the second storage does not exceed the capacity of the data according to the transaction, modify the database according to data related to another transaction prior to the transaction, recorded in the journal information stored in the second storage, and
based on confirming that the database is modified according to the data related to the another transaction prior to the transaction:
record the data according to the transaction in other journal information related to the database and stored in the first storage; and
change a path where the journal information related to the database is stored from the second storage to the first storage.

8. The electronic device of claim 7, wherein the instructions, when executed by the at least one processor individually or collectively, further cause the electronic device to:
based on confirming that the database is not modified according to the data related to the another transaction prior to the transaction:
store a copy of the journal information stored in the second storage in the first storage, and
change a path where the journal information related to the database is stored from the second storage to the first storage.

9. The electronic device of claim 6, wherein the transaction for modifying data in the database includes a write transaction.

10. The electronic device of claim 1, wherein the second storage is mounted within the electronic device.

11. The electronic device of claim 1, wherein the instructions, when executed by the at least one processor individually or collectively, further cause the electronic device to:
confirm, using the information related to the database stored in the memory, whether storing the journal information related to the database in the second storage from among the first storage or the second storage is permitted.

12. The electronic device of claim 1, wherein the journal information includes information about changes to the database by the transaction.

13. The electronic device of claim 1, wherein a lack of available capacity of the second storage causes failure to generate the journal information in the second storage.

14. An electronic device comprising:
memory including a first storage area and a second storage area having a faster access speed than the first storage area, the memory storing instructions; and
at least one processor, comprising processing circuitry,
wherein the instructions, when executed by the at least one processor individually or collectively, cause the electronic device to:
confirm, using information related to a database stored in the memory, whether managing a database using the second storage area from among the first storage area or the second storage area is permitted,
based on confirming that managing the database using the second storage area is permitted, execute a function of generating, in the second storage area, journal information related to the database stored in the first storage area, and
based on the execution of the function:
based on the journal information stored in the second storage area, update the journal information stored in the second storage area according to a transaction related to the database, and
based on identifying that the journal information is not generated in the second storage area by execution of the function, generated the journal information in the first storage area.

15. A method performed by an electronic device including memory including a first storage and a second storage having a faster access speed than the first storage, the method comprising:
confirming, using information related to a database stored in the memory, whether managing the database using the second storage from among the first storage or the second storage is permitted;
based on confirming that managing the database using the second storage is permitted, executing a function of generating, in the second storage, journal information related to the database stored in the first storage; and
based on the execution of the function:
based on the journal information stored in the second storage, updating the journal information stored in the second storage according to a transaction related to the database, and
based on identifying that the journal information is not generated in the second storage by the execution of the function, generating the journal information in the first storage.

16. The method of claim 15, further comprising:
in response to confirming that managing the database using the second storage is permitted, determining whether available capacity of the second storage satisfies a specified criterion;
in a case of determining that the available capacity of the second storage satisfies the specified criterion, setting a path where the journal information related to the database is stored in the second storage; and
based on identifying that the journal information is not generated in the second storage by the execution of the function, setting a path where the journal information is stored in the first storage for generating the journal information related to the database in the first storage.

17. The method of claim 16,
in response to identifying that the journal information is generated in the second storage by execution of the function, confirming whether the path where the journal information is stored corresponds to the second storage; and
in response to confirming that the path where the journal information is stored corresponds to the second storage, storing, in the first storage, information about the path.

18. The method of claim 16, further comprising:
in response to confirming that managing the database using the second storage is permitted, determining whether an available capacity of the second storage satisfies a specified criteria;
in case of determining that the available capacity of the second storage satisfies the specified criteria, generating the journal information in the second storage, and store information about the path where the journal information is stored in the first storage; and
in case of determining that the available capacity of the second storage does not satisfy the specified criteria, generating the journal information in the first storage.

19. The method of claim 18,
based on detecting a transaction related to the database, determining whether an available capacity of the second storage exceeds a capacity of data according to the transaction; and
based on determining that the available capacity of the second storage exceeds the capacity of the data according to the transaction, recording the data according to the transaction in the journal information stored in the second storage.

20. One or more non-transitory computer-readable storage media storing one or more computer programs including computer-executable instructions that, when executed by at least one processor of an electronic device including memory including a first storage and a second storage having a faster access speed than the first storage individually or collectively, cause the electronic device to perform operations, the operations comprising:
confirming, using information related to a database stored in the memory, whether managing the database using the second storage from among the first storage or the second storage is permitted;
based on confirming that managing the database using the second storage is permitted, executing a function of generating, in the second storage, journal information related to the database stored in the first storage; and
based on the execution of the function:
based on the journal information stored in the second storage, updating the journal information stored in the second storage according to a transaction related to the database, and
based on identifying that the journal information is not generated in the second storage by the execution of the function, generate the journal information in the first storage.
